(19) United States
(12) Patent Application Publication
(10) Pub. No.: US 2018/0123255 A1
(43) Pub. Date: May 3, 2018

(54) Polarized Filtenna, such as a Dual Polarized Filtenna, and Arrays and Apparatus Using Same

(71) Applicant: Nokia Solutions and Networks Oy, Espoo (FI)

(72) Inventor: David Hendry, Auchenflower (AU)

(21) Appl. No.: 15/338,942

(22) Filed: Oct. 31, 2016

(51) Int. Cl. H01Q 13/10; H01R 24/38; H01Q 1/36; H01Q 1/48; H01Q 9/04

(52) U.S. Cl. CPC H01Q 13/10; H01R 24/38; H01R 2103/00; H01Q 1/48; H01Q 9/0407; H01Q 1/36

(57) ABSTRACT

An apparatus includes a filtenna. The filtenna includes a block having a waveguide formed therein, and having first and second ends, wherein the first end is closed and the second end radiates to free space. The filtenna also includes multiple patch elements suspended within the waveguide, ordered from a first patch element at the first end of the waveguide to a final patch element at the second end of the waveguide. The filtenna further includes one or more ports at the first end of the waveguide. Each of the one or more ports is electrically coupled to the first patch element, and is for coupling to a corresponding antenna polarization. A dual-polarized filtenna is possible, as are transmitters, receivers, base stations, and the like. An array of filtennas may be created and used, and the filtenna(s) may be used for transmission, reception, or both.

### TECHNICAL FIELD

This invention relates generally to antennas for wireless communications and, more specifically, relates to antennas with at least one polarization and filtering properties.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, after the main part of the detailed description section.

In current time-division-duplexed (TDD) radios, a dual-polarized antenna is typically physically separate from two identical filters (also physically separate), each connected by two 50 Ohm transmission lines. The antenna is a resonator that couples RF energy to free space, while the filter is made from resonators that are coupled together such that only wanted frequencies pass through.

While this is a beneficial construction, this could be improved.

### BRIEF SUMMARY

This section is intended to include examples and is not intended to be limiting.

In an exemplary embodiment, an apparatus comprises a filtenna. The filtenna comprises a block having a waveguide formed therein, and having first and second ends, wherein the first end is closed and the second end radiates to free space. The filtenna also comprises a plurality of patch elements suspended within the waveguide, ordered from a first patch element at the first end of the waveguide to a final patch element at the second end of the waveguide. The filtenna further comprises at least one port at the first end of the waveguide, each of the at least one ports electrically coupled to the first patch element, each of the at least one ports for coupling to a corresponding antenna polarization.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 presents a sixth order, dual-polarized filtenna in accordance with an exemplary embodiment, where the dual-polarized filtenna is considered to have one single-polarized filtenna for each polarization;

FIG. 3 presents a close up of a portion of the dual-polarized filtenna from the example of FIG. 2, containing coaxial probes, each coaxial probe coupled to a polarization;

FIG. 4 presents a fourth order, dual-polarized filtenna in accordance with an exemplary embodiment;

FIG. 5 presents a dual-polarized filtenna comprising silver-plated ceramic disks, in accordance with an exemplary embodiment;

FIG. 6 presents part of a dual-polarized filtenna similar to the filtenna in FIGS. 2 and 3 but with a TEFLON support and a different probe configuration;

FIG. 7 presents a 3×3 array of filtennas for an exemplary embodiment;

FIG. 8 presents an exemplary design showing dielectric crosses suspended within an air cavity, which has very low loss performance, at the expense of increased size; and

FIG. 9 presents total efficiency of one of the single-polarized filtennas.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe various dual polarized filtenna (e.g., a combination of filter(s) and antenna(s)) arrays. Additional description of these arrays is presented after a system into which the exemplary embodiments may be used is described.

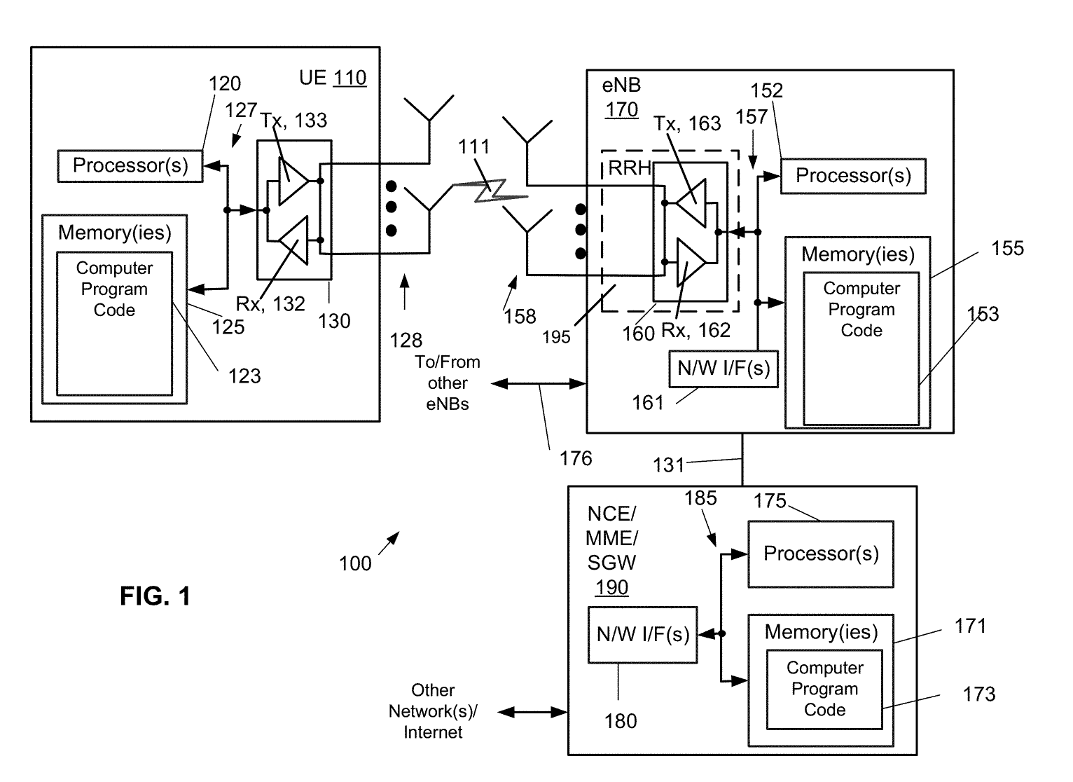

Turning to FIG. 1, this figure shows a block diagram of one possible and non-limiting exemplary system in which the exemplary embodiments may be practiced. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 communicates with eNB 170 via a wireless link 111.

The eNB (evolved NodeB) 170 is a base station (e.g., for LTE, long term evolution) that provides access by wireless devices such as the UE 110 to the wireless network 100. The eNB 170 includes one or more processors 152, one or more memories 155, one or more network interfaces (N/W l/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The instant embodiments concern one way to implement the one or more antennas 158. The one or more memories 155 include computer program code 153. The one or more network interfaces 161 communicate over a network such as via the links 176 and 131. Two or more eNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

The wireless network 100 may include a network control element (NCE) 190 that may include MME (Mobility Management Entity)/SGW (Serving Gateway) functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

Having thus introduced one suitable but non-limiting technical context for the practice of the exemplary embodiments of this invention, the exemplary embodiments will now be described with greater specificity.

As described above, in current TDD radios, a dual-polarized antenna is typically physically separate from two identical filters (also physically separate), each connected by two 50 Ohm transmission lines. The antenna is a resonator that couples RF energy to free space, while the filter is made from resonators that are coupled together such that only wanted frequencies pass through. This construction could be improved by integrating a dual-polarized antenna with two filters while maintaining good port isolation, maintaining good cross polarization, having low insertion loss, and providing good efficiency, as embodied by the filtennas described herein.

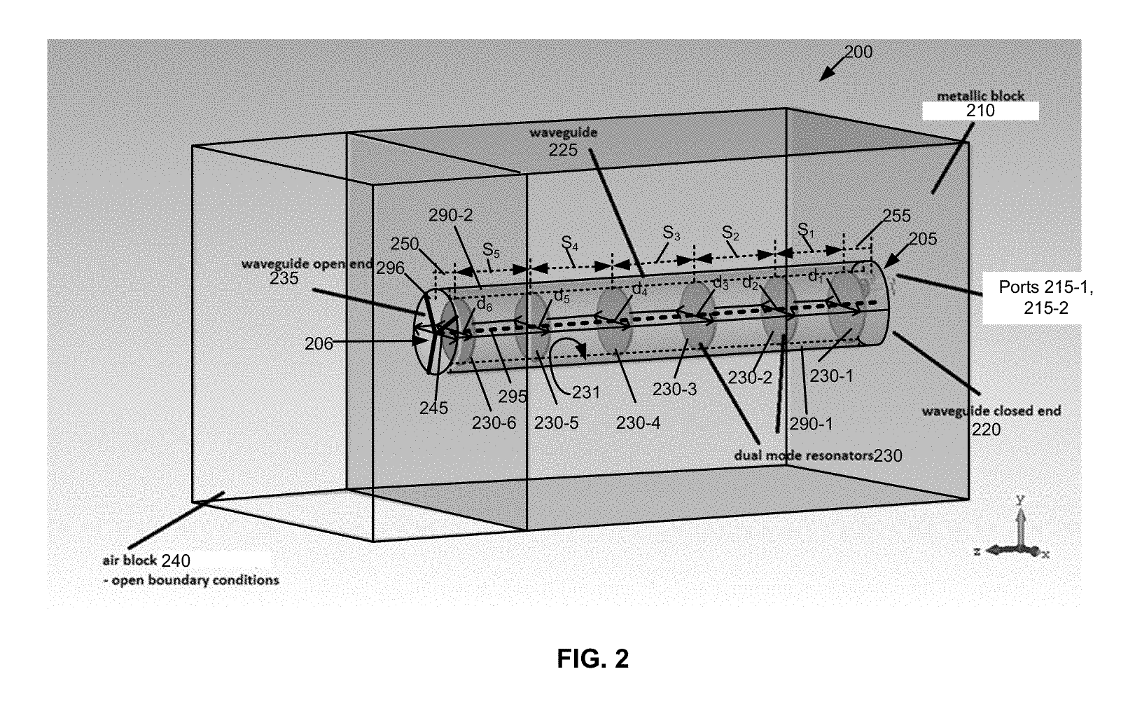

An exemplary dual linearly-polarized filtenna contains degenerate dual-mode resonators in an in-line waveguide. See FIG. 2, which presents a sixth order, dual-polarized filtenna 200 (e.g., used as the antennas 158 in FIG. 1) in accordance with an exemplary embodiment, where the dual-polarized filtenna 200 is considered to have one single-polarized filtenna for each polarization. There is a waveguide 205 cut into and through a metallic block 210. As such, the waveguide 205 comprises a cavity 206. The metallic block 210 need not be metal but can be other conductive materials. The waveguide 205 is, in this example, a common, continuous, and cylindrical waveguide cavity 206 having a wall 231 (a single inner surface in this example, but there could be multiple walls 225 in other examples). A waveguide housing (not shown) could be made from ceramic or plastic. In this case, the inside walls 231 of the waveguide would need to be made metallic, such as being silver plated. Also, the ceramic or plastic could have a temperature expansion coefficient such that the resonators had minimal temperature frequency drift.

The waveguide has a diameter 245 and includes a number (in this example, six) dual-mode resonators 230-1 through 230-6. Each of the dual-mode resonators 230 has a corresponding diameter, d: dual-mode resonator 230-1 has diameter d₁; dual-mode resonator 230-2 has diameter d₂; dual-mode resonator 230-3 has diameter d₃; dual-mode resonator 230-4 has diameter d₄; dual-mode resonator 230-5 has diameter d₅; and dual-mode resonator 230-6 has diameter d₆. In the simplest case, a resonator is dual mode when it is similar in two dimensions. However, it is possible to get two (or more) modes with completely different field patterns to resonate at the same frequency in a structure that is not similar in two (or more) dimensions. Note that the diameters d are less than the diameter 245 of the waveguide 205, and the resonators 230 are suspended within the waveguide 205 and do not electrically or physically contact the wall 231 in at least this embodiment. The dual-mode resonators 230 are also referred to as patch elements 230, as the patch elements 230 are not limited to the circular shape illustrated by FIG. 2, and also these elements only resonate when coupled to the antenna polarizations. That is, when the filtenna 200 is not being used for communication, the patch elements are conductive pieces of material that do not resonate. It should be noted that a rectangular patch will break the two dimensional symmetry, forcing the two filtenna polarizations to be at different frequencies, which maybe useful in certain instances. Any patch that looks the same when rotated 90 degrees will create degenerate (same frequency) modes.

The dual-mode resonators 230 are spaced apart by spacings S: dual-mode resonators 230-1 and 230-2 are spaced apart by spacing S₁; dual-mode resonators 230-2 and 230-3 are spaced apart by spacing S₂; dual-mode resonators 230-3 and 230-4 are spaced apart by spacing S₃; dual-mode resonators 230-4 and 230-5 are spaced apart by spacing S₄; and dual-mode resonators 230-5 and 230-6 are spaced apart by spacing S₅. Concerning the spacings S, for a tuned filter with good return loss across the pass band, the spacings S typically should not be the same. Generally, the resonators towards either end 220, 235 of the filter will have smaller spacings than the central resonators.

The separation S between each patch element 230 controls the couplings (bandwidths) while the size of each patch element 230 controls the frequencies. For the frequencies, the resonant frequency of each patch is controlled by its size. For instance, for a circular patch, a larger diameter will create a patch with lower resonant frequency. It should be noted that, for certain shapes of patch elements, the relationship between size and resonant frequency is more complex. In particular, each of the two modes is not independently controlled by adjusting the distance between parallel sides of a rectangle and therefore the rectangle's aspect ratio. However, changing the length (for instance) will largely change one mode and to a lesser extent change the other mode.

All patch elements can be similar in shape, but generally the outermost patch element 230-6 will be slightly smaller (due to having a larger surrounding space, illustrated as air block 240) and the innermost patch element 230-1 will be slightly larger (due to having a smaller surrounding space, as seen by spacing 255 relative to the spacing S₁ for instance) than the central patch elements 230 (e.g., 230-2 through 230-5). For a narrow bandwidth filter, this structure creates an electrically long waveguide as the patches need large separations to achieve the required small bandwidths (couplings). As the filter bandwidth increases, the patch separations decrease and the filtenna length decreases.

At one end of the waveguide 205, two ports 215-1 and 215-2 couple to the first dual-mode resonator 230 (note the spacing 255 between the waveguide closed end 220 and the dual-mode resonator 230-1), which then couples to a second dual-mode resonator 230-2 further along the waveguide 205, and the second dual-mode resonator 230-2 then couples to a third dual-mode resonator 230-3 even further along the waveguide 205, and the like. The last dual-mode resonator 230-6 is close (spaced apart by spacing 250) to the open end 235 of the waveguide 205, coupling energy to free space, where the free space is illustrated by the air block 240, which may be used in some situations to simulate boundary conditions. Although the end 235 is referred to as “open”, this end 235 radiates into free space and the end 235 could be covered with low loss plastic with minimal effect on performance. It is believed that most antennas have an opaque plastic radome covering that is transparent to RF frequencies. Regarding the term “close”, the distance 250 the last resonator 230-6 is from the waveguide open end 235 dictates the external coupling or Q of the last resonator. This is a measure of how much energy the last resonator radiates into free space. For a narrow band filtenna (say less than 10% fractional bandwidth), the last resonator needs to only couple a small amount of energy into free space, therefore the last resonator needs to be further embedded within the waveguide. A wide band filtenna on the other hand needs to couple a large amount of energy into free space, therefore the last resonator needs to be further out of the waveguide, and could potentially be totally outside of the waveguide, suspended above the ground plane (e.g., the end 235 of the waveguide 205, which is grounded).

Note for maximum filtenna selectivity, the last resonator 230-6 should be critically coupled (not over or under coupled) into free space. Over coupling can still give a good performing filtenna, but the selectivity will be reduced. Under coupling will compromise the return loss of the filtenna.

There is one filter on each polarization of the dual-modes, with the filtering order equal to the number of dual-mode resonators/patch elements 230. In this way, two coupled resonator filters radiate energy into free space. Good port isolation, good cross-polarization, low insertion loss and good efficiency are achieved. The diameter (in a circular example) of the waveguide 205 may be less than half a wavelength in size, allowing a filtenna array with half-wavelength element spacings, S.

One way to implement this filtenna is with flat circular discs (the dual-mode resonators 230) suspended within a cylindrical waveguide, but could also be implemented as any rotationally symmetrical-shaped patch elements within a rotationally symmetrical-shaped waveguide (say square patch elements in a square waveguide). The rotational symmetry may be 90 degree rotationally symmetry, which means the shape looks the same when rotated 90 degrees. This means the patch elements 230 would typically be circular or square, but all the shapes in between (cross, 4 or 8 point star, etc.) may be used. This symmetry is required if both polarizations need to be at the same frequency. However, there may be scenarios where it is beneficial for the two polarizations to be at different frequencies, which means the symmetry would be relaxed and the patches could take any form (though rectangular might be simplest). The circular shape might be preferred for ease of manufacturing.

The patch elements 230 could be either dielectric or metallic, but at high frequencies (say 28 GHz), the increased loss of even the best performing ceramics would mean metallic discs might be preferred. Potentially any metal could be useful, but if the metal was not copper, gold or silver, it would be beneficial to silver plate the metal. The dielectric could be ceramic but also could be plastic. If the part was to be completely silver plated, the quality factor of the dielectric would not matter, but if not silver plated, the dielectric would ideally have a high quality factor (for decreased insertion loss) and high dielectric constant (for decreased size). There are many high quality factor ceramics with a wide range of dielectric constants, however no plastics are known having high enough dielectric constant and quality factor to be useful un-plated. Of course, if such a plastic is found, it could be used un-plated.

The waveguide cavity could also be made out of dielectric material with metal plating for decreased size, but again at high frequencies air might be preferable. The patch elements in this case could either be embedded within the dielectric material, say with a Low Temperature Cofired Ceramic (LTCC) process or similar, or excluded altogether. When excluded, the filtenna would look more like silver plated ceramic discs coupled together with face centered circular holes through smaller waveguide sections.

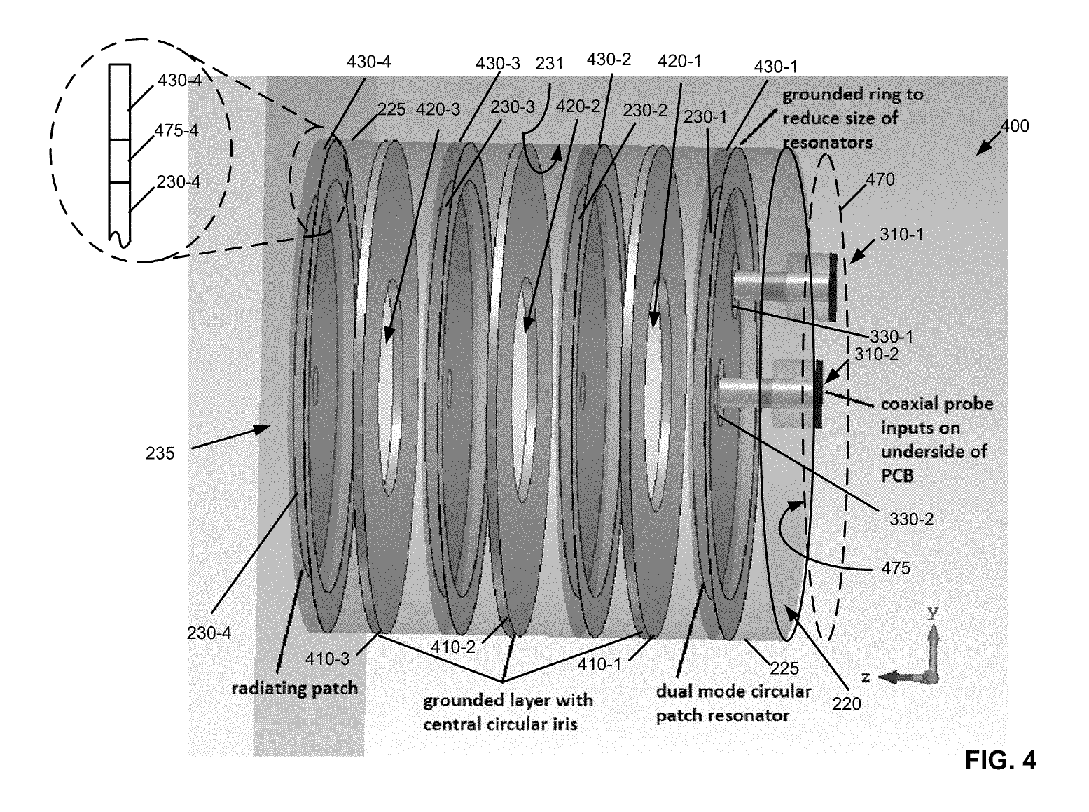

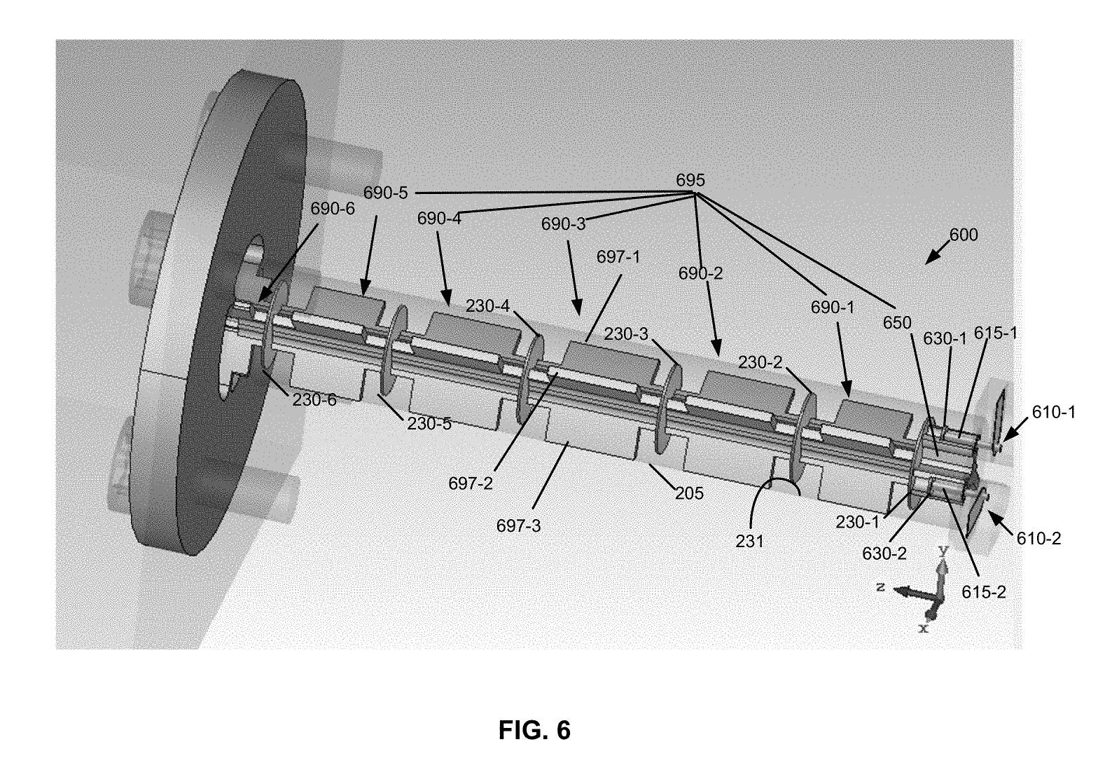

A number of options are available for suspending the resonators 230 in the waveguide 202. For instance, FIG. 2 also illustrates insulating rails 290-1 and 290-2 running along a length of the waveguide 205, the insulating rails 290 configured to symmetrically offset the patch elements 230 from all walls 231 of the waveguide. There would usually be three or four insulating rails 290, evenly spaced about the circumference of the waveguide, but only two rails are shown for clarity. As another example, a suspension system comprises an insulating rod (illustrated by dashed line 295) supported at the closed end 220, the open end 230, or both the ends of the waveguide and running down a center of the waveguide, skewering and supporting each patch element 230. This example shows a Y-shaped support 296 at the open end 235, and another of these could also be placed (not shown) at the closed end 220. FIGS. 4 and 6 show additional suspension systems.

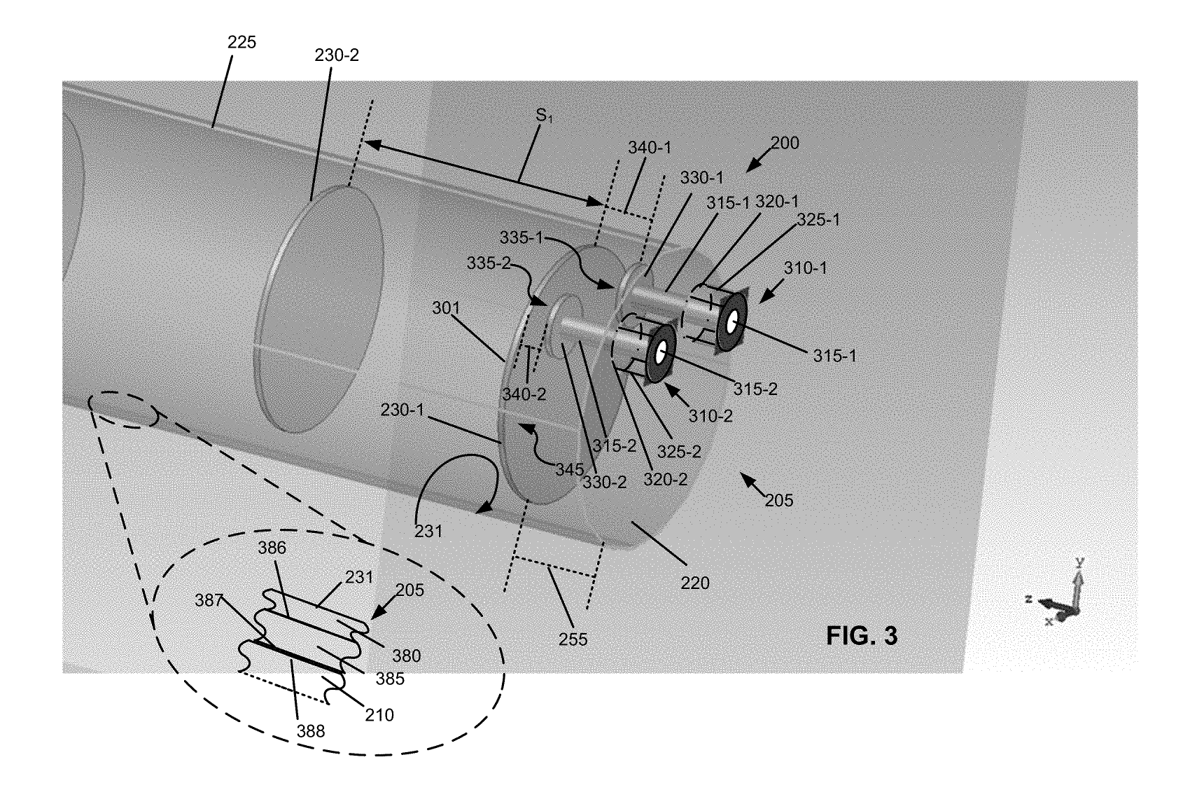

FIG. 3 presents a close up of a portion of the dual-polarized filtenna from the example of FIG. 2, containing coaxial probes 310-1 and 310-2, each probe 310 to accept one of the two polarizations. This is an illustration that the ports 215 may be implemented as end mounted coaxial probes 310-1 and 310-2, electrically coupled to the first dual-mode resonator 230-1 with small gaps 340-1 and 340-2, respectively. In particular, the term “port” refers to the general area where energy is input/output to the structure, of which a coaxial probe is one possible implementation. The filtering bandwidth dictates how much energy needs to couple into the first resonator 230-1. However, in this case, coupling is a function of the probe end cap diameter (that is, diameter of probe ends 330-1 and 330-2) as well as the gaps (340-1 and 340-2). To add to this, there is an optimum diameter and gap that critically couples the first resonator 203-1 while also maximizing the port-to-port isolation. Maximum port-to-port isolation occurs when the magnetic field from the probe shaft 315 cancels the electric field of the probe end 330. Generally, the wider the bandwidth, the smaller the gap 340. It is noted that gaps 340-1 and 340-2 are actually the same, even though the figure might make it appear they are different. This is just a perspective problem, as the probe ends 330 sit out from the patch perimeter a little bit.

The probes 310 should be towards the perimeter 301 of the resonator 230-1 for increased coupling and a larger gap is also possible for decreased sensitivity. That is, it is possible that having the largest gap for 340-1 and 340-2 could be beneficial, as the largest would reduce the gap sensitivity. The largest gap occurs when the probes 310 are closest to the perimeter 301 of the patches 230, where there is maximum electric field. However, as commented above, the best gap may be one that achieves critical coupling while also maximizing port-to-port isolation. The probes 310 should also have an angle of 90 degrees between them so that each probe 310 only couples to a single polarization of the dual-mode resonator 230-1.

In this example, the coaxial probes 310 are similarly designed. The following description discusses both probes 310 and their respective elements. Each coaxial probe 310-1/310-2 comprises a probe shaft 315-1/315-2, a conductive shield 325-1/325-2 that is connected to and terminates at the closed end 220 of the waveguide 225. The probe shaft 315-1/315-2 passes through an opening 320-1/320-2 in the closed end 220. It is assumed that the closed end 220 and the block 210 are grounded. The probe shaft 315-1/315-2 connects to a probe end 330-1/330-2 having a side 335-1/335-2 that opposes a side 345 of the dual-mode resonator 230-1, where there is a gap 340-1/340-2 between a side 335-1/335-1 and a side 345. It is noted that the probe ends 330 do not have to be circular and could be other shapes, such as a probe end 330 that uses a long thin track angled at 45 degrees instead of a circular probe end, and this has better port-to-port isolation than the circular probe ends 330 in FIG. 3. It is additionally noted that a probe end 330 is not technically radiating; instead, the coupling is evanescent or near field.

FIG. 3 also illustrates another possible implementation, where the waveguide 205 is formed of dielectric material 385 with metal plating 380 on an interior wall 386 of the waveguide 205. The interior wall 386 faces the patch elements 230, and the exterior wall 387 faces an interior 388 of the block 210. Note that the block 210 may not be metallic in this instance.

Multiple techniques for supporting the patch elements 230 within the waveguide 225 may be used. Insulating rails (not shown) could run along the length of the waveguide 225 to symmetrically offset the patch elements 230 from the waveguide walls 231, but as the electric field is highest around the perimeter of the patch elements 230, the amount of material for the insulating rails should be minimized. For a rectangular waveguide, two or more insulating rails could be used (e.g., one rail on opposing walls for a total of two rails), although one or more rails per wall could be used. Similarly, for the cylindrical example in FIG. 2, at least two insulating rails could be used, although four rails may be better. Alternatively, as the electric field is zero at each center of a patch element 230, an insulating rod (not shown) supported by at least one waveguide end could run down the center of the waveguide, skewering and supporting each patch element 230. The patch elements 230 can have a small hole at their centers with minimal effect on performance. Alternatively, each patch element 230 could be printed on a PCB and layered between hollow frames to create each waveguide section between each patch element 230.

The diameter 245 (see FIG. 2) of a circular air waveguide 205 with metallic patch elements 230 can be made slightly smaller than half a wavelength. As such, an array of these filtennas 200 could be built with optimal half-wavelength separation as created by the physical structure of the array. This separation allows optimal beamforming with good gain and side lobe control. These filtennas 200 could possibly be beneficial to any TDD radio at any frequency and up to large fractional bandwidths (perhaps as much as 30 percent ), but an air-filled waveguide would probably only be useful at higher frequencies (say above 10 GHz), due to large electrical size. As is known, a fractional bandwidth is bandwidth divided by center frequency. For instance the shown filtenna has (28.5−27)/27.75=5.4% fractional bandwidth.

Additionally, although emphasis herein is placed on TDD radios, the filtennas described herein could be used for FDD, and the Rx and Tx would be on two physically separate filtennas, each at different frequencies. Otherwise, Rx and Tx could be on each polarization of the same filtenna, but the patches would need to break symmetry, with one mode at Rx frequencies and the other mode at Tx frequencies.

Turning to FIG. 4, this figure presents a fourth order, dual-polarized filtenna 400 in accordance with an exemplary embodiment. In this example, between each set of the resonators/patch elements 230 is a grounded layer 410 with a central circular iris 420. The grounded layers 410-1, 410-2, and 410-3 are respectively between the set of resonators 230-1 and 230-2, the set of resonators 230-2 and 230-3, the set of resonators 230-3 and 230-4. An outside circumference of the grounded layers 410 connects with the waveguide walls 231, which is grounded and therefore grounds the layers 410. The patch elements 230 are referred to as dual mode circular patch resonators in this example. Additionally, each resonator 230 is supported and suspended by a grounded ring 430, which serves to reduce the size of the resonators 230. That is, patch elements 230-1, 230-2, 230-3, and 230-4 are suspended in part by grounded rings 430-1, 430-2, 430-3, and 430-4, respectively. An outside circumference of the rings 430 has electrical and physical contact with the waveguide walls 231, which is grounded and therefore grounds the rings 430. The patch elements 230 are electrically insulated from the grounded rings 430, e.g., by an insulator. For instance, the insulating ring 475-4 insulates the patch element 230-4 from the ring 430-4, and the other sets of rings 430 and patch elements 230 would be similarly designed. The patch element 230-4 is the radiating patch at the open end 235 of the waveguide 225. The coaxial inputs 310-1 and 310-2 are shown near the closed end 220 of the waveguide 225 of the filtenna 400, as are their corresponding probe ends 330-1, 330-2. The inputs for the coaxial probes 310 are on the “underside” 475 (in this example) of a PCB, a portion of which is illustrated by reference 470.

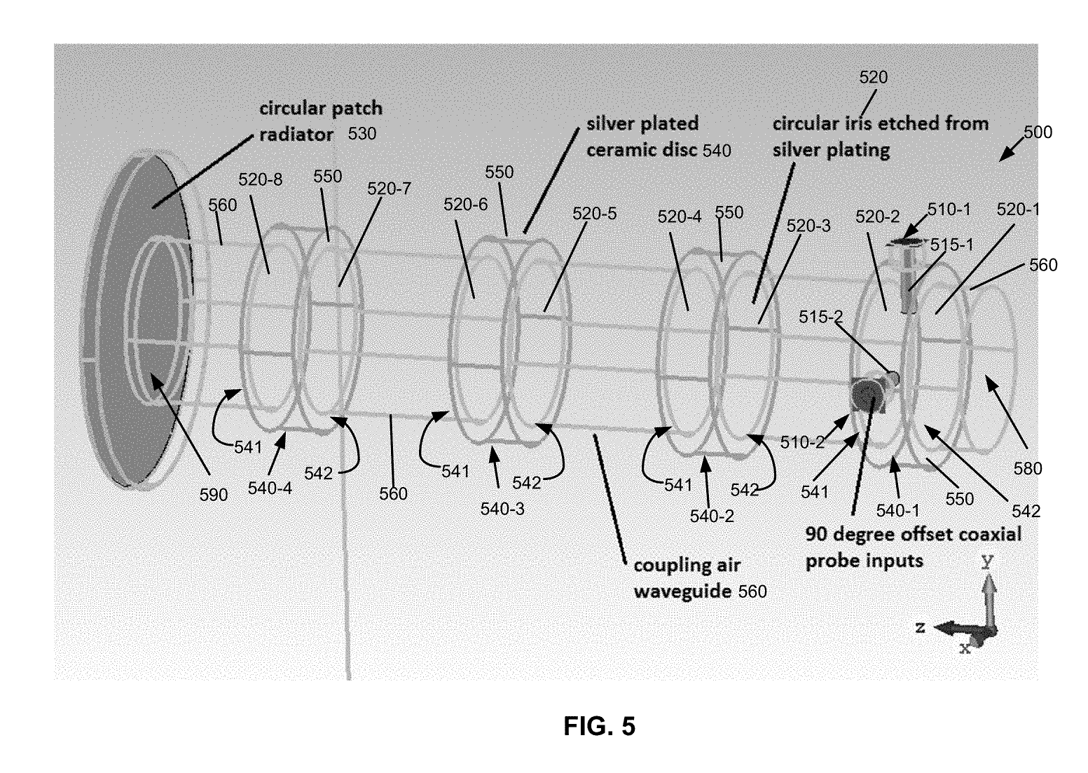

FIG. 5 presents a dual-polarized filtenna 500 comprising silver-plated ceramic disks 540, in accordance with an exemplary embodiment. This example has four silver plated ceramic discs 540-1, 540-2, 540-3, and 540-4. On each side 541, 542 of a disc 540, there is a circular iris 520 etched from the silver plating 550. The inside circumference of the circular irises align with the outside circumference of the coupling air waveguide 560, and the waveguide 560 is filled with air. On the open end 590 of the waveguide 560, there is a circular patch radiator 530. Near the closed end 580 of the waveguide 560, there is one ceramic disc 540-1 into which two coaxial probes 510-1 and 510-2 are positioned to couple their respective polarizations into the waveguide 560. The coaxial probes 510-1, 510-2 are 90 degrees offset. The coaxial probes 510 are similar to the coaxial probes 310 described previously, but no probe ends 330 are used and instead a probe shaft 515-1 or 515-2 ends in the body of the ceramic disc 540-1.

Turning to FIG. 6, this figure presents part of a dual-polarized filtenna 600 similar to the filtenna in FIGS. 2 and 3 but with a TEFLON (a trademark of the DuPont Corporation, and commonly known as polytetrafluoroethylene (PTFE)) support 695 and a different probe configuration. The PTFE support 695 has a number of different sections 690-1, 690-2, 690-3, 690-4, 690-5, and 650. In this example there are ports 610-1 and 610-2 that have probe shafts 615-1 and 615-1 that lead to probe ends 630-1 and 630-2. The probe shafts 615-1 and 615-1 and probe ends 630-1 and 630-2 are supported and positioned relative to the resonator 230-1 (as described in reference to FIG. 3 and the gaps 340-1, 340-2) by the PTFE section 650. The other PTFE sections 690-1, 690-2, 690-3, 690-4, 690-5 position and suspend the resonators 230-1 through 230-6 in the waveguide 205. The sections 690 position the resonators 230 approximately in the center of the waveguide 205 and also create corresponding spacings S between the resonators. Each section 690 comprises three wings 697-1, 697-2, and 697-3 that position and suspend a resonator 230 approximately in the center of the waveguide 205, e.g., by contacting a wall 231 of the waveguide 205 and skewering an opening (e.g., in the center) of the resonator. Note that there could be additional or fewer wings 697. Each section 690 typically supports one corresponding resonator 230, but each section 690 could also cooperate with another section 690 to support one or two resonators 230, e.g., via one or multiple openings in the resonators 230.

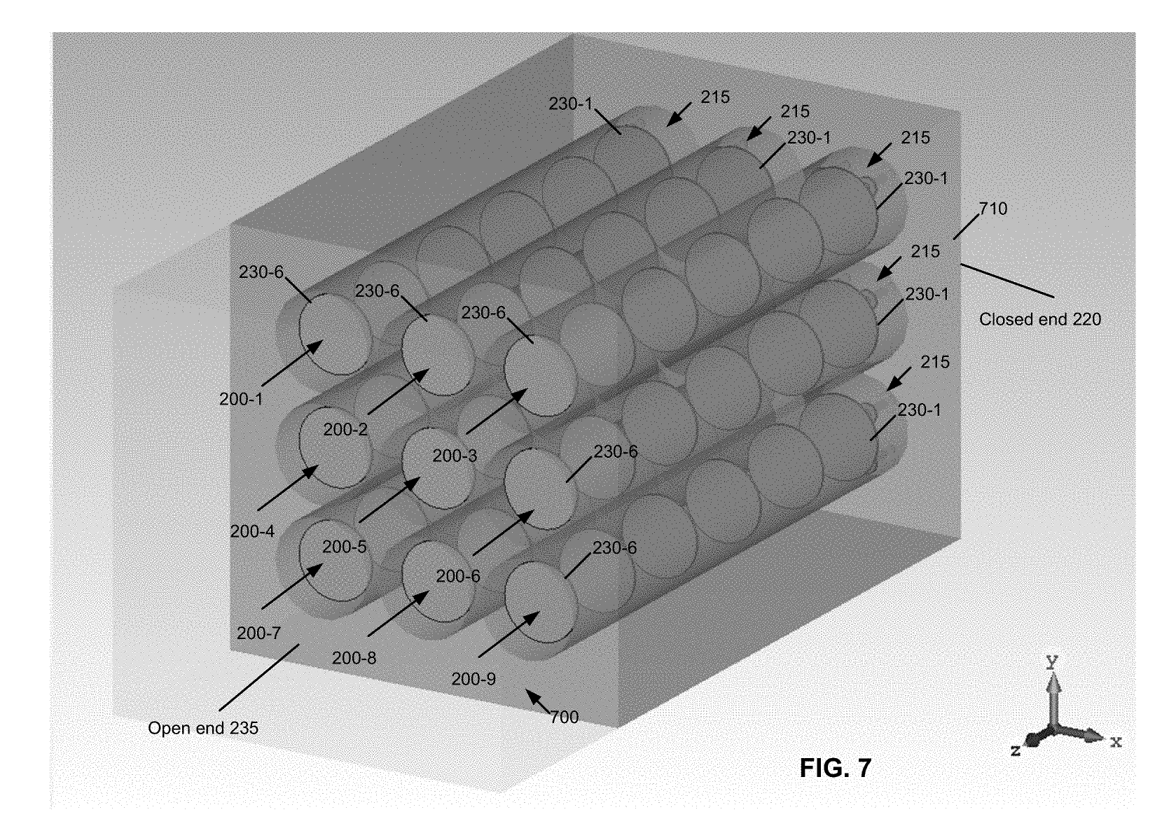

Referring to FIG. 7, this figure presents a 3×3 array 700 of filtennas 200 for an exemplary embodiment. In this example, the array 700 comprises filtennas 200-1, 200-2, 200-3, 200-4, 200-5, 200-6, 200-7, 200-8 and 200-9. Each filtenna 200 is in the block 710. This array 700 can be applied to any of the embodiments herein, although the filtenna 200 of FIG. 2 is used in this example.

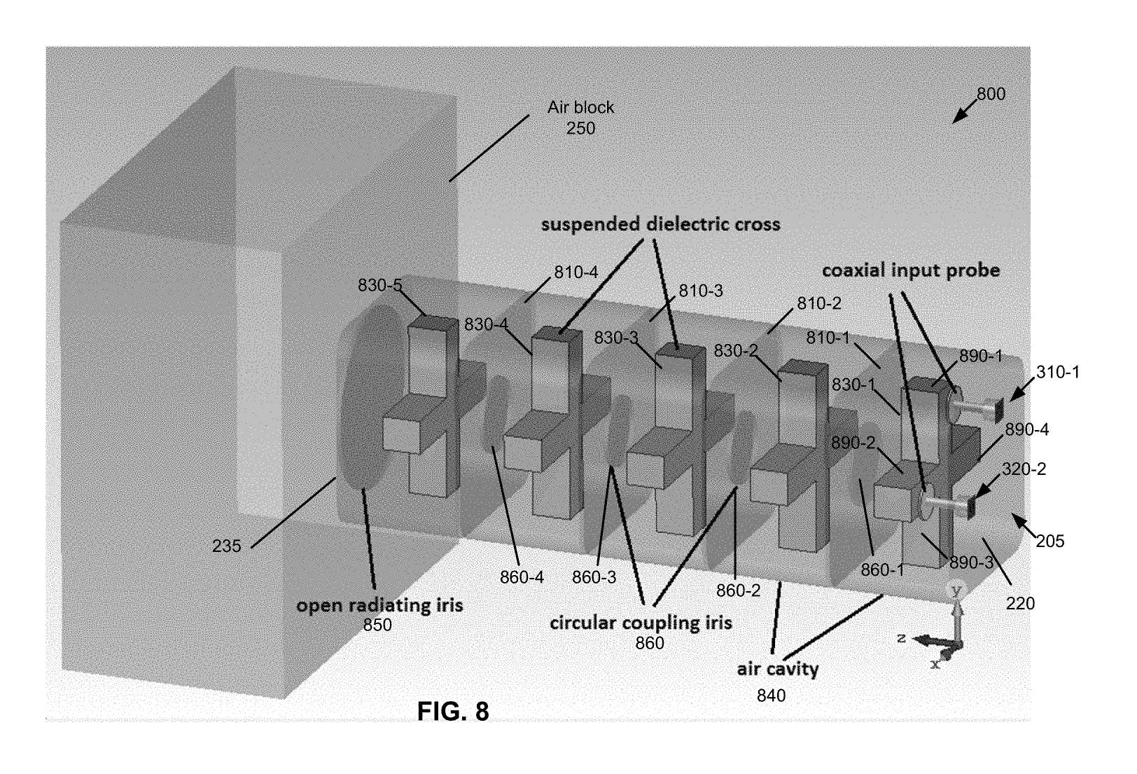

FIG. 8 presents another exemplary design showing dielectric crosses suspended within an air cavity. This design has very low loss performance, at the expense of increased size. In this example, the filtenna 800 comprises five suspended dielectric crosses 830-1, 830-2, 830-3, 830-4, and 830-5, which act as the patch elements (e.g., 230), each comprising parts 890-1, 890-2, 890-3, and 890-4. Note that this is a square example, such that the waveguide 205 has a generally square profile. Between each set of suspended dielectric crosses 830 is a circular coupling iris 860, similar to the grounded layer 410 with circular iris 420 of FIG. 4: grounded layer 810-1 with its coupling iris 860-1 is located between the dielectric crosses 830-1 and 830-2; grounded layer 810-2 with its coupling iris 860-2 is located between the dielectric crosses 830-2 and 830-3; grounded layer 810-3 with its coupling iris 860-3 is located between the dielectric crosses 830-3 and 830-4; and grounded layer 810-4 with its coupling iris 860-4 is located between the dielectric crosses 830-4 and 830-5. These are within an air cavity 840 of the waveguide 205. The coaxial input probes 310-1 and 320-2 are shown at the closed end 220 of the waveguide 205 and each probe 310-1 or 310-2 couples to one part 890-1 or 890-2, respectively, of the cross 830-1, and these two parts 890-1 and 890-2 have a separation of 90 degrees. There is an open radiating iris 850, which radiates into free space (illustrated by the air block 250), at the open end 235 of the waveguide 205.

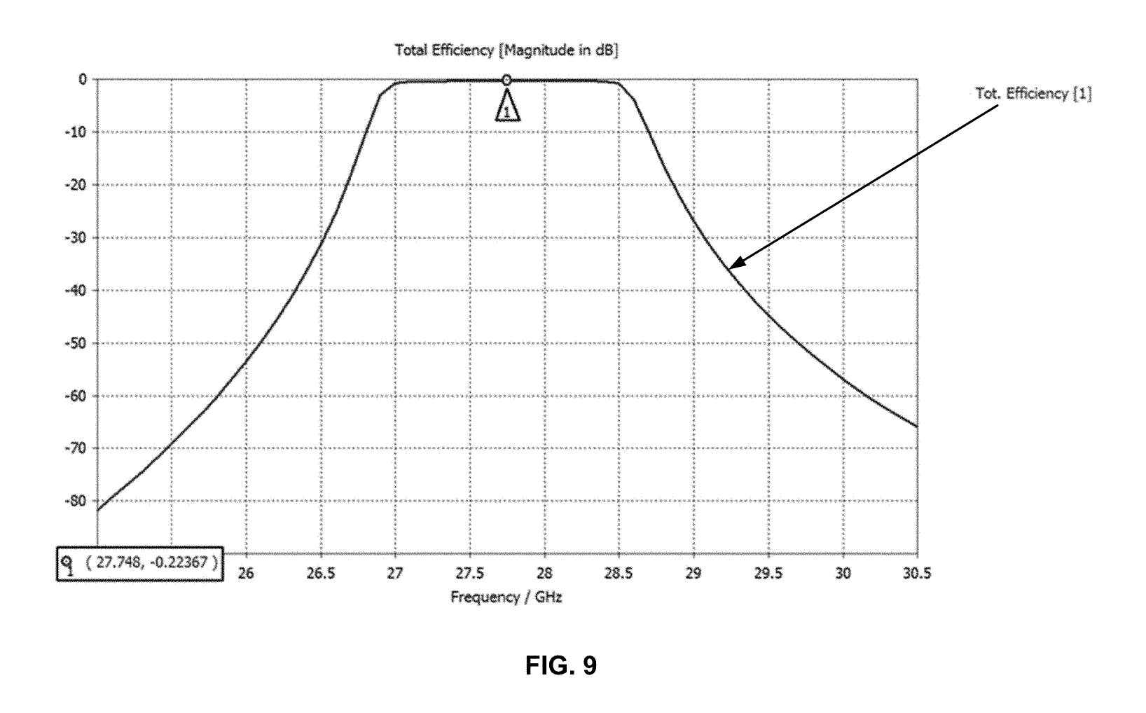

FIG. 9 presents total efficiency of one of the single-polarized filtennas. More particularly, this figure presents total efficiency (“Tot. Efficiency”) of one of the single-polarized filtennas (e.g., designed as in FIG. 2). As can be seen, the efficiency is 0 dB (zero decibels) from about 27 GHz to about 28.5 GHz. This is an example illustrating the filtering properties for one of the single-polarized antennas

Additional examples and comments are as follows. Long waveguides are less of an issue at high frequencies (say>=28 GHz), but at lower frequencies, more compact solutions may be implemented. Introducing grounded layers between patch elements having centrally located irises can decrease the patch couplings and reduce the filtenna length, at the expense of resonator Q (i.e., increased filter insertion loss or antenna efficiency). It is possible to produce designs between 2-6 GHz that have iris-hole couplings (including an iris hole coupling to the outermost patch element 230-6). Also, introducing a large hole at the center of each patch element 230, so that each patch element 230 forms a ring, decreases the patch couplings (at the expense of resonator Q). This might be cheaper than grounded layers to decrease filtenna length.

Additional examples are as follows. Example 1. An apparatus, comprising: a filtenna, comprising: a block having a waveguide formed therein, and having first and second ends, wherein the first end is closed and the second end radiates to free space; a plurality of patch elements suspended within the waveguide, ordered from a first patch element at the first end of the waveguide to a final patch element at the second end of the waveguide; and at least one port at the first end of the waveguide, each of the at least one ports electrically coupled to the first patch element, each of the at least one ports for coupling to a corresponding antenna polarization.

Example 2. The apparatus of example 1, wherein: the waveguide is a rotationally symmetrical-shaped waveguide; and the plurality of patch elements are a plurality of rotationally symmetrical-shaped patch elements. Note that this may apply to any filtenna or array of filtennas described herein.

Example 3. The apparatus of example 2, wherein the at least one port is two ports. Note that this may apply to any filtenna or array of filtennas described herein.

Example 4. The apparatus of example 2, wherein the plurality of rotationally symmetrical-shaped patch elements are spaced such that the patch elements towards the first end and the second end have smaller spacings than the spacings between central resonators in the plurality of resonators. Note that this may apply to any filtenna or array of filtennas described herein.

Example 5. The apparatus of example 1, wherein the block is metallic, is silver plated ceramic, or is silver plated plastic. Note that this may apply to any filtenna or array of filtennas described herein.

Example 6. The apparatus of example 1, wherein the patch elements comprise a metal, a dielectric, a silver-plated metal, or a metal-plated dielectric. Note that this may apply to any filtenna or array of filtennas described herein.

Example 7. The apparatus of example 1, wherein: the waveguide is cylindrical; and the patch elements are circular.

Example 8. The apparatus of example 1, wherein: the waveguide is rectangular; and the patch elements are rectangular.

Example 9. The apparatus of example 1, further comprising at least one of a transmitter, receiver, and transceiver connected to the filtenna. Note that this applies to any filtenna or array of filtennas described herein.

Example 10. The apparatus of example 9, further comprising a base station comprising the at least one of the transmitter, receiver, or transceiver. Note that this applies to any filtenna or array of filtennas described herein.

Example 11. The apparatus of example 1, wherein there are two ports, each of the ports comprises a coaxial probe comprising a center probe and a conductive shield, wherein for each coaxial probe: the center probe passes through the first end of the waveguide without contacting the first end; the conductive shield connects to and terminates at the first end; and the center probe connects to a probe end having a side that opposes a side of the first patch element and being separated from the patch element by a gap.

Example 12. The apparatus of example 1, further comprising a suspension system contacting at least one wall of the waveguide and configured to suspend the patch elements away from all walls of the waveguide.

Example 13. The apparatus of example 12, wherein the suspension system comprises a plurality of insulating rails running along a length of the waveguide, the insulating rails configured to symmetrically offset the patch elements from all walls of the waveguide.

Example 14. The apparatus of example 12, wherein the suspension system comprises an insulating rod supported at the first end, the second end, or both the first and second ends of the waveguide and running down a center of the waveguide, skewering and supporting each patch element.

Example 15. The apparatus of example 12, wherein the suspension system comprises a support having a number of different sections, each section supporting at least one of the patch elements and creating a corresponding space between the patch elements, each section comprising a plurality of wings contacting a wall of the waveguide and at least one patch element and positioning the at least one patch element within the waveguide.

Example 16. The apparatus of example 15, wherein: there are two ports, each of the ports comprises a coaxial probe comprising a center probe and a conductive shield, wherein for each coaxial probe: the center probe passes through the first end of the waveguide without contacting the first end; the conductive shield connects to and terminates at the first end; and the center probe connects to a probe end having a side that opposes a side of the first patch element and being separated from the patch element by a gap; the apparatus further comprises a support at the closed end of the waveguide, the support supporting the center probes and probe ends and position the probe ends with a gap relative to the first patch element.

Example 17. The apparatus of example 1, further comprising a plurality of the filtennas arranged in an array. Any of the filtennas described herein may be in an array (and it's possible to use different filtennas as part of the array).

Example 18. The apparatus of example 1, further comprising grounded layers between patch elements, the grounded layers having centrally located irises.

Example 19. The apparatus of example 18, wherein the patch elements comprise suspended dielectric crosses, and the waveguide has a square profile.

Example 20. The apparatus of example 18, wherein each of the plurality of patch elements is suspended within the waveguide by a corresponding grounded ring that contacts an inner surface of the waveguide.

Example 21. The apparatus of example 1, wherein the waveguide is formed of dielectric material with metal plating on an interior wall of the waveguide, the interior wall facing the patch elements.

Example 22. The apparatus of example 1, wherein the plurality of patch elements comprise silver plated ceramic discs, each disc having a circular iris etched in the silver plating on two opposing sides of the disc, and wherein a circumference of an interior of the iris aligns with a wall of the waveguide.

Example 23. The apparatus of example 22, further comprising a circular patch radiator covering and being larger than an opening for the waveguide at the second end of the waveguide.

Example 24. The apparatus of example 22, wherein: the at least one port is two ports; each of the two ports comprises a coaxial probe comprising a center probe and a conductive shield, wherein for each coaxial probe the center probe passes into a body of the first patch element and the conductive shield connects to and terminates at the first end; and the two coaxial probes have an angle of 90 degrees between them so that each probe only couples to a single polarization of the patch elements.

Without in any way limiting the scope, interpretation, or application of the claims appearing below, a technical effect of one or more of the example embodiments disclosed herein is creating a multiple-polarity antenna that also acts as a filter for each of the polarities. Another technical effect of one or more of the example embodiments disclosed herein is integrating a dual-polarized antenna with two filters while maintaining good port isolation, maintaining good cross polarization, having low insertion loss, and providing good efficiency. Another technical effect of one or more of the example embodiments disclosed herein is creating an array of such filtennas.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
% percent
dB decibels
eNB (or eNodeB) evolved Node B (e.g., an LTE base station)
FDD frequency-division-duplex
GHz gigahertz
I/F interface
LTCC low temperature cofired ceramic
LTE long term evolution
MME mobility management entity
NCE network control element
N/W network
PCB printed circuit board
RF radio frequency
RRH remote radio head
Rx receiver or reception
SGW serving gateway
TDD time-division-duplex
Tx transmitter or transmission
UE user equipment (e.g., a wireless, typically mobile device)

What is claimed is:

1. An apparatus, comprising:
a filtenna, comprising:
a block having a waveguide formed therein, and having first and second ends, wherein the first end is closed and the second end radiates to free space;
a plurality of patch elements suspended within the waveguide, ordered from a first patch element at the first end of the waveguide to a final patch element at the second end of the waveguide; and
at least one port at the first end of the waveguide, each of the at least one ports electrically coupled to the first patch element, each of the at least one ports for coupling to a corresponding antenna polarization.

2. The apparatus of claim 1, wherein:
the waveguide is a rotationally symmetrical-shaped waveguide; and
the plurality of patch elements are a plurality of rotationally symmetrical-shaped patch elements.

3. The apparatus of claim 2, wherein the at least one port is two ports.

4. The apparatus of claim 2, wherein the plurality of rotationally symmetrical-shaped patch elements are spaced such that the patch elements towards the first end and the second end have smaller spacings than the spacings between central resonators in the plurality of resonators.

5. The apparatus of claim 1, wherein the block is metallic, is silver plated ceramic, or is silver plated plastic.

6. The apparatus of claim 1, wherein the patch elements comprise a metal, a dielectric, a silver-plated metal, or a metal-plated dielectric.

7. The apparatus of claim 1, wherein:
the waveguide is cylindrical; and
the patch elements are circular.

8. The apparatus of claim 1, wherein:
the waveguide is rectangular; and
the patch elements are rectangular.

9. The apparatus of claim 1, further comprising at least one of a transmitter, receiver, and transceiver connected to the filtenna.

10. The apparatus of claim 9, further comprising a base station comprising the at least one of the transmitter, receiver, or transceiver.

11. The apparatus of claim 1, wherein there are two ports, each of the ports comprises a coaxial probe comprising a center probe and a conductive shield, wherein for each coaxial probe:
the center probe passes through the first end of the waveguide without contacting the first end;
the conductive shield connects to and terminates at the first end; and
the center probe connects to a probe end having a side that opposes a side of the first patch element and being separated from the patch element by a gap.

12. The apparatus of claim 1, further comprising a suspension system contacting at least one wall of the waveguide and configured to suspend the patch elements away from all walls of the waveguide.

13. The apparatus of claim 12, wherein the suspension system comprises a plurality of insulating rails running along a length of the waveguide, the insulating rails configured to symmetrically offset the patch elements from all walls of the waveguide.

14. The apparatus of claim 12, wherein the suspension system comprises an insulating rod supported at the first end, the second end, or both the first and second ends of the waveguide and running down a center of the waveguide, skewering and supporting each patch element.

15. The apparatus of claim 12, wherein the suspension system comprises a support having a number of different sections, each section supporting at least one of the patch elements and creating a corresponding space between the patch elements, each section comprising a plurality of wings contacting a wall of the waveguide and at least one patch element and positioning the at least one patch element within the waveguide.

16. The apparatus of claim 15, wherein:
there are two ports, each of the ports comprises a coaxial probe comprising a center probe and a conductive shield, wherein for each coaxial probe:
the center probe passes through the first end of the waveguide without contacting the first end;
the conductive shield connects to and terminates at the first end; and
the center probe connects to a probe end having a side that opposes a side of the first patch element and being separated from the patch element by a gap;
the apparatus further comprises a support at the closed end of the waveguide, the support supporting the center probes and probe ends and position the probe ends with a gap relative to the first patch element.

17. The apparatus of claim 1, further comprising a plurality of the filtennas arranged in an array.

18. The apparatus of claim 1, further comprising grounded layers between patch elements, the grounded layers having centrally located irises.

19. The apparatus of claim 18, wherein the patch elements comprise suspended dielectric crosses, and the waveguide has a square profile.

20. The apparatus of claim 18, wherein each of the plurality of patch elements is suspended within the waveguide by a corresponding grounded ring that contacts an inner surface of the waveguide.

21. The apparatus of claim 1, wherein the waveguide is formed of dielectric material with metal plating on an interior wall of the waveguide, the interior wall facing the patch elements.

22. The apparatus of claim 1, wherein the plurality of patch elements comprise silver plated ceramic discs, each disc having a circular iris etched in the silver plating on two opposing sides of the disc, and wherein a circumference of an interior of the iris aligns with a wall of the waveguide.

23. The apparatus of claim 22, further comprising a circular patch radiator covering and being larger than an opening for the waveguide at the second end of the waveguide.

24. The apparatus of claim 22, wherein:
the at least one port is two ports;
each of the two ports comprises a coaxial probe comprising a center probe and a conductive shield, wherein for each coaxial probe the center probe passes into a body of the first patch element and the conductive shield connects to and terminates at the first end; and
the two coaxial probes have an angle of 90 degrees between them so that each probe only couples to a single polarization of the patch elements.
